(19) United States
(12) Patent Application Publication
(10) Pub. No.: US 2005/0115087 A1
(43) Pub. Date: Jun. 2, 2005

(54) Optical torque and angle sensor

(76) Inventor: Ralf Noltemeyer, Wernau (DE)

Correspondence Address: KENYON & KENYON, ONE BROADWAY, NEW YORK, NY, 10004, US

(21) Appl. No.: 10/504,265

(22) PCT Filed: Feb. 8, 2002
(86) PCT No.: PCT/EP02/01312

(51) Int. Cl. G01D 21/00

(52) U.S. Cl. 33/1 PT

(57) ABSTRACT

Detection of patterned regions on code-carriers assigned to rotatable components is achieved by means of an optical sensor arrangement having illumination arrangement. Upon rotation of coded regions, reflections thereof are detected and focused on surface-arrays on a surface of an ASIC. A multiturn-code-carrier is assigned to a rotatable component, the multiturn-code-carrier having a detectable surface and being rotatable in a ratio which is different from the rotating ratio of code-carrier, on which said coded regions are provided.

### FIELD OF THE INVENTION

The present invention relates to a method and an apparatus for determining the position of at least one surface having patterned regions.

### BACKGROUND INFORMATION

A plurality of optical sensors currently are used in vehicle applications to detect the positions of moveable components of the vehicle. Optical sensors replace a mechanical switching element and may allow the establishment of a digital communication concept within a vehicle. Optical sensors may be used to measure the revolutions of a crankshaft of an internal combustion engine or to count the revolutions of a vehicle driver's steering wheel to detect the angle of the front wheels of a vehicle with respect to the vehicle's body.

U.S. Pat. No. 5,930,905 discusses a method and device for angular measurement of a rotatable body. That rotatable body is mounted to be rotated by more than 360° and includes a number of uniform angular markers or teeth. The rotatable body cooperates with at least two further rotatable bodies, which have another number of uniform angular markers or teeth, that angles 0 and v of this two further rotatable bodies are determined and the angular position φ of the rotatable body whose angle is to be measured, is calculated from the angles 0 and ψ, taking into consideration the prevailing geometric conditions. In a first step the whole number k is determined by forming the difference between the number of the teeth M of a gear wheel, multiplied by the angle 0 and the number of teeth of the gear wheel multiplied by the angle ψ. This number is divided by the angle Ω whereas in a second step the angle φ which is to be tacted, is determined starting from this k-value by evaluating the equation

$$φ = \frac{m \cdot ψ + ( m + 1 ) \cdot θ - ( 2 m + 1 ) \cdot k \cdot Ω}{2 n}$$

and, in case of negative angles φ, subsequently the full angle period is added to this value. German Published Patent Document No. 100 41 095 discusses a device for measuring the angle and/or a torque on a rotatable body. The angle of rotation is detected by means of magnetic or optical sensors. In an exemplary embodiment two devices are provided, each being provided with two optical readable code traces. The two code traces of each device are embodied in the same manner and are arranged in such a manner that said devices are off-set against each other to allow allocated sensors to output a digital signal. The angle of rotation is calculated from the off-set of two digital signals. In another exemplary embodiment a torsional element having a certain stiffness and is arranged between the two devices. A torque which is transmitted by the rotatable body may thus be calculated from the different angles of the two devices. The device according to the disclosure of German Published Patent Document No. 100 41 095 may be used in the steering column shaft of a motor vehicle.

International Published Patent Application No. WO 00/28285 discusses an optical sensor. This sensor is used for determining the position of a moveable surface having patterned regions of high and low reflectivity to EMR, the sensor including an application specific integrated circuit (ASIC) at least one lens and at least one EMR-source. The ASIC includes at least one array of EMR-sensitive detectors and processing arrangement, the EMR-source facilitating illumination of the surface and the at least one lens facilitating the focusing of reflected EMR from the surface and generating an image on the at least one array of EMR-sensitive detectors corresponding to the pattern on the surface. Said ASIC, the at least one lens and the at least one EMR-source are enclosed in a single housing providing for accurate optical alignment of these elements with respect to each other and integrated as a single replaceable module. The processing arrangement of the ASIC facilitates processing of the image to determine the position of the pattern on the surface.

For single turn applications (360°) torque and angle sensors (TAS) are frequently used. To detect a plurality of rotations, i.e. multiturns of the rotatable element this TAS is operated to electrically count the number of turns. That implies that the TAS is switched with respect to the battery voltage and, on ignition of the internal combustion engine of the vehicle, is connected to supply voltage. At ignition on, the sensor (TAS) measures in a approximately 500 μs an actual position and counts the number of turns. After ignition has been switched off the sensor works in an inactive mode (i.e. sleeping mode). In this inactive mode the refreshing time of said TAS increases to decrease the average of the supply current to operate the TAS. However, the TAS counts the turns in the inoperative mode as well.

The multiturn-operation strategy of the TAS provides that the supply current for the TAS, even in its inoperative mode, discharges the battery and decreases the time between two ignition-cycles which may cause motor starting problems. Thus, the recovery period for the vehicles battery is considerably decreased causing significant problems on ignition of the internal combustion engine, which is extremely critical at low ambient temperatures.

### SUMMARY OF THE INVENTION

According to the present invention, a torque and angle module (TAS) is disclosed for detection of multiturns of a moveable component in a vehicle which does not discharge the battery of the respective vehicle. Instead, a gear is provided between a standard code disk having patterned surface regions thereon and a further additional code disk. By means of one sensor element, packaged within the TAS-module, at least two code carriers such as disks may be surveyed contactless, transferring optical signals from the respective surface patterned regions of the code carriers into digital processable information. The number of multiturns of a moveable vehicle component, such as a steering wheel and its associated steering column shaft are detected by means of a modified nonius-calculation or an n-dimensional nonius calculation.

An optical system and an illumination system are arranged within a TAS-module's housing. The illumination system may allow for sequential illumination of different code carriers such as code disks, being arranged on a rotating shaft or another rotating component. Due to the small size of ASIC and sensor, said components fit into a housing of small size as well, which may be packaged close to the movable component the number of turns of which are to be detected. According to different exemplary embodiments of the present invention, a sequential illumination of input code-carrier and a multiturn information carrier may be achieved as well as a sequential illumination of output code carrier and a multiturn information carrier, depending on the respective spatial conditions. The multiturn disk-element may be arranged either assigned to a bearing's side on a shaft or on a shaft's circumferential torsion in a distance from a bearing or at a side of the torsion bar.

The TAS-multiturn imaging and illumination principle according to the present invention provides for measurement of three different code carriers such as code disks, having 12 tracks, by means of two detective arrays (8 tracks) on the ASIC's surface. The respective carriers provided with code patterns include different reflectivity characteristics to enhance contrast-generation of the ASIC, provided on top of the TAS-module's housing.

Maximum contrast generation is important to enhance distinction between non-symmetrical turning marks and surfaces of laser marks.

To increase robustness of the measurement principle, sequential measurement of two code carriers such as code disks may be performed at the same time. This improves reliability of the TAS-module-application.

The movement principle as disclosed may be used for single turn sensor arrangements, as well as electrical multiturns sensors. Further, the measurement principle according to the present invention may be used in connection with a mechanical multiturn sensor.

### BRIEF DESCRIPTION OF THE DRAWINGS

FIG. 1 shows an illumination system of a rotating surface having patterned regions according to known systems.

FIG. 2 shows the mechanical configuration of a torque/angle-sensor (TAS) cooperating with two code surfaces having patterned regions thereon.

FIG. 3.1 shows output phase signals according to the nonius principle for various gear issues.

FIG. 3.2 shows output phase signals according to the nonius principle for various gear issues.

FIG. 4.1 shows sequential measurements of code carriers such as disks.

FIG. 4.2 shows sequential measurements of code carriers such as disks.

FIG. 4.3 shows sequential measurements of code carriers such as disks.

FIG. 5 shows a gear assembly providing a multiturn disk in a first exemplary embodiment according to the present invention.

FIG. 6 shows a gear assembly providing a multiturn disk in a second exemplary embodiment according to the present invention.

FIG. 7 shows a gear assembly with a bevel-gear assembly in a third exemplary embodiment of the present invention.

### DETAILED DESCRIPTION

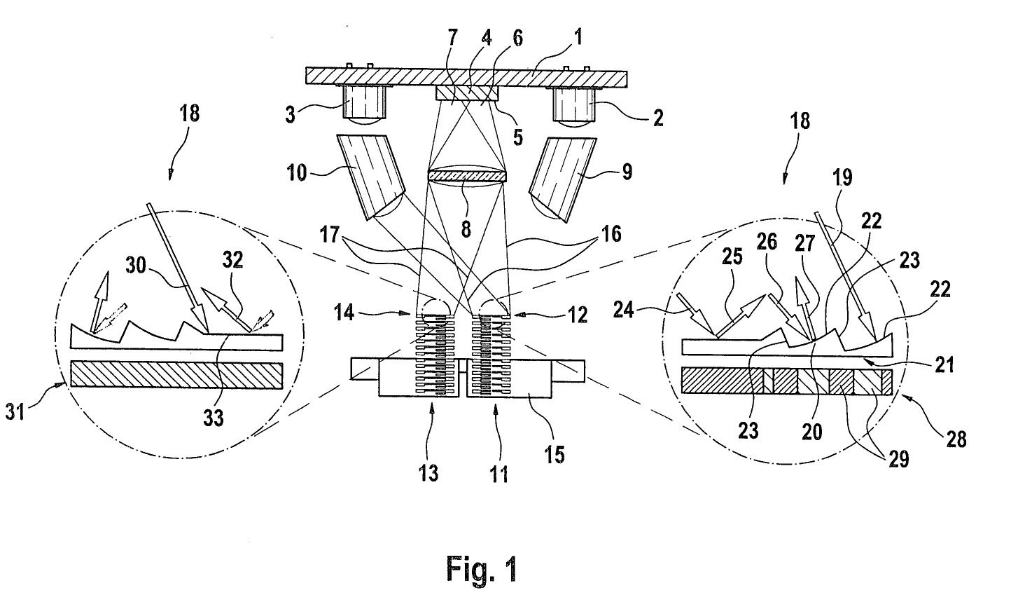

FIG. 1 shows an illumination system of a rotating surface having patterned regions according to known systems, being assigned to respective surfaces of code carrying elements.

As may be seen from FIG. 1, a printed circuit board 1 includes a first light emitting diode (LED) 2 and a second LED 3. Between said light emitting diodes 2, 3, respectively, an ASIC is arranged. Said ASIC 4 includes a surface 5 which is oriented towards a lens 8. Said ASIC-surface 5 of the ASIC 4 includes a first array 6 and a second array 7. Below said first LED 2 and said second LED 3 a first light guide 9 and a second guide 10 are provided, each of which detects a first coded pattern 12 and a second coded pattern 14, each of which are provided on circumferential surfaces of a first code disk 11 and a second code disk 13. According to the exemplary embodiments given in FIG. 1 the first code disk 11 and the second code disk 13 are mounted to a shaft 15 which is only given schematically here. Reference numeral 16 identifies reflected rays from the first coded pattern 12, arranged on the surface of the first code disk 11, whereas reference numeral 17 identifies reflected rays from the second coded pattern 14 of the second code disk 13. By means of the lens 8 arranged between the first coded pattern 12 and the second coded pattern 14 and the ASIC 4 arranged at the bottom of the printed circuit board 1, the reflected rays 16, 17 are focused on the first array 6 and the second array 7 arranged on the surface 5 of the ASIC 4. The profile and the shape of the first coded pattern 12 and the second coded pattern 14 provided on the surfaces of the first code disk 11 and the second code disk 13 are given in greater detail in an enlarged view 18.

Reference numerals 19, 20, respectively, identify a first turning mark and a second turning mark. The first turning mark 19 and the second turning mark 20 are shaped in a saw-teeth-profile 21 including a curved surface 22. The profile 21 further includes an inclined surface 23. A first beam 24 results in a reflected first beam 25. A second beam 26 reaching the curved surface 22 of the profile 21 results in a reflected second beam 27. The reflected first beam 25 and the reflected second beam 27 generate a optical ASIC-information 28 on the surface 5 of the ASIC 4 mounted between the first LED 2 and the second LED 3. The optical ASIC-information 28 includes bright/dark-profile 29 on the respective first array 6 and the second array 7 on the ASIC's surface 5. By means of the ASIC 4, the bright/dark-profile 29 is turned into digital information which may be processed further in components not given in greater detail in FIG. 1.

An optical ASIC information 31 given on the left hand side of FIG. 1 is generated according to the radiation reflected by the surface of the second coded pattern 14 of the second code disk 13. The arrow 32 identifies reflected radiation, resulting from irradiation of flat surface 33 of the second coded pattern 14.

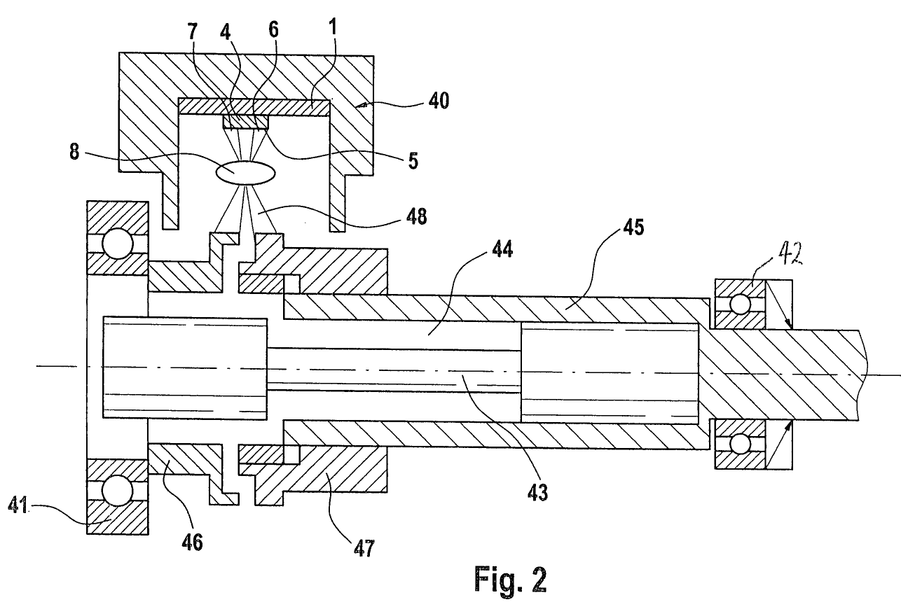

FIG. 2 shows the mechanical configuration of a torque/angle-sensor (TAS) cooperating with two coding surfaces having patterned regions.

The printed circuit board 1 is mounted within a TAS-module 40, including the ASIC 4 having a surface 5 oriented towards the lens 8. On a shaft 45 an output-code-disk 46 and an input-code-disk 47 are arranged, defining a detection area 48. Within the detection area 48, the surfaces of the output-code-disk 46 and the input-code-disk 47, respectively, are detected and focused by means of the lens 8 on the respective first array 6 and the second array 7 on the surface 5 of the ASIC 4.

Within the hollow interior 44 of the shaft 45 a torsion element 43 is mounted. Said shaft 45 is rotatably mounted by means of a first ball bearing 41 and a second ball bearing 42.

The arrangement of FIG. 1 and FIG. 2 provides that the TAS module 40, according to this configuration, discharges a vehicle's battery even if the TAS module 40 is not in use, i.e. in a “sleeping” mode.

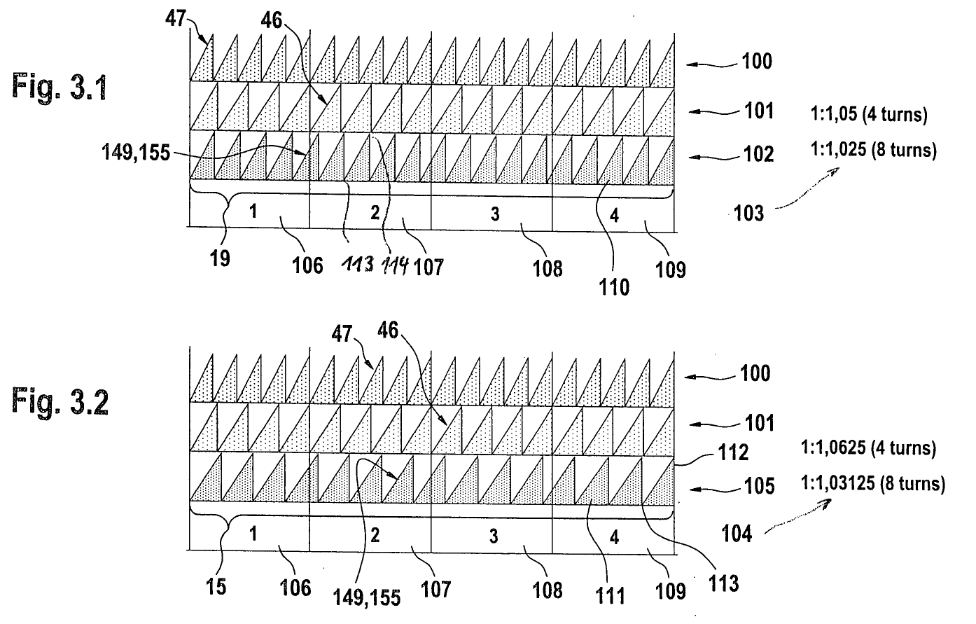

FIGS. 3.1 and 3.2 show output phase signals according to the nonius principle for various gear ratios according to the present invention.

FIG. 3.1 shows an input code signal 100 of the input-code-disk 47 having a saw-profile. Reference numeral 101 depicts a saw-profile of an output code signal 101. According to the present invention a multiturn code signal 102 is generated by means of an additional multiturn disk 149, 155, respectively. Said multiturn-code-disks 149, 155, respectively, are mounted by means of an intermediate gearing which has a preselected gear ratio 103. By the preselected gear ratio 103 a plurality of single multiturn signals 110 according to the selected first gear ratio may be generated. Said single multiturn signals 110 each includes a multiturn signal 110 according to a first gear-ratio 103, and generates according to the signal sequence given in FIG. 3.1 19 signal peeks 112. Each single multiturn signal 110 is defined by a signal peak 112 and a signal end 113. Summarized over 4 turns 106, 107, 108 and 109 the input-code-disk 47 generates 20 input signals, whereas the output-code-disk 46 generates 16 output signals. However, due to the first gear ratio 103 the multiturn code signal 102 includes 19 single multiturn signals.

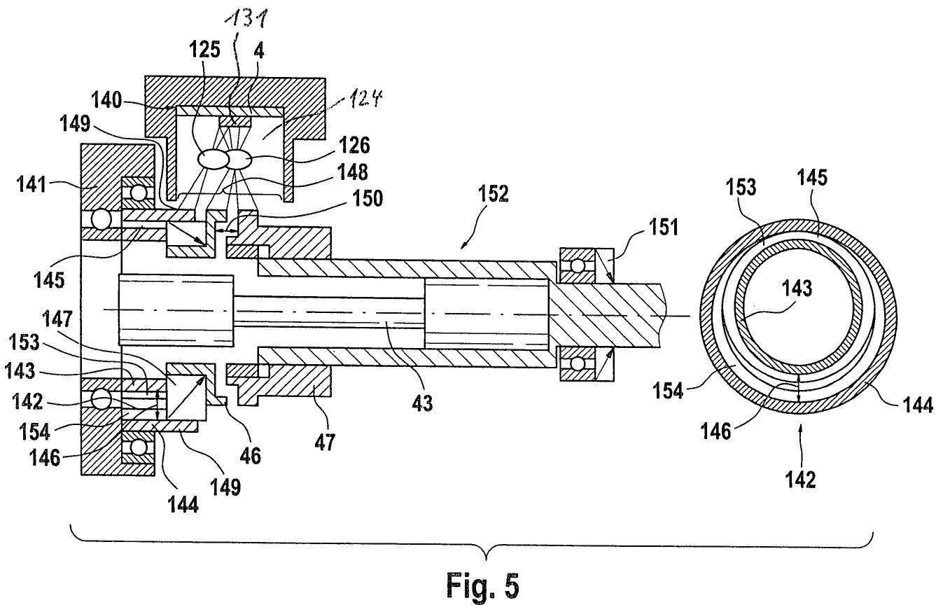

In FIG. 3.2 the input code signal 100 is the same as given in the example relating to the first gear ratio, i.e. 20 single input code signals. Further, the output code signal 101 includes 16 single output signals summarized over the period of 4 turns 106, 107, 108 and 109. According to a second gear ratio 104, the second multiturn code signal sequence includes 15 single multiturn signals 110 which according to the nonius-principle may allow calculation of the number of turns of a respective rotatable element such as steering wheel shaft 152 (see FIGS. 5, 6 and 7). The second multiturn-code-disk signal sequence 105 is generated by means of multiturn disk arrangements 149, 155 (see FIGS. 5, 6 and 7).

Due to the different gear ratios 103 and 104 in relation to the multiturn code signal sequences 102 and 105, the single multiturn signals 111 of the sequence 105 in FIG. 3.2 are longer as compared to the signal duration of the single multiturn signals 110 according to the gear ratio given in FIG. 3.1.

The bright images on the ASIC are produced at positions in which the light may reach the ASIC. This happens, when the light is reflected at the turning marks and focused by the lens. The dark images on the ASIC are produced when the light is reflected at a laser mark and does not reach the lens and the ASIC.

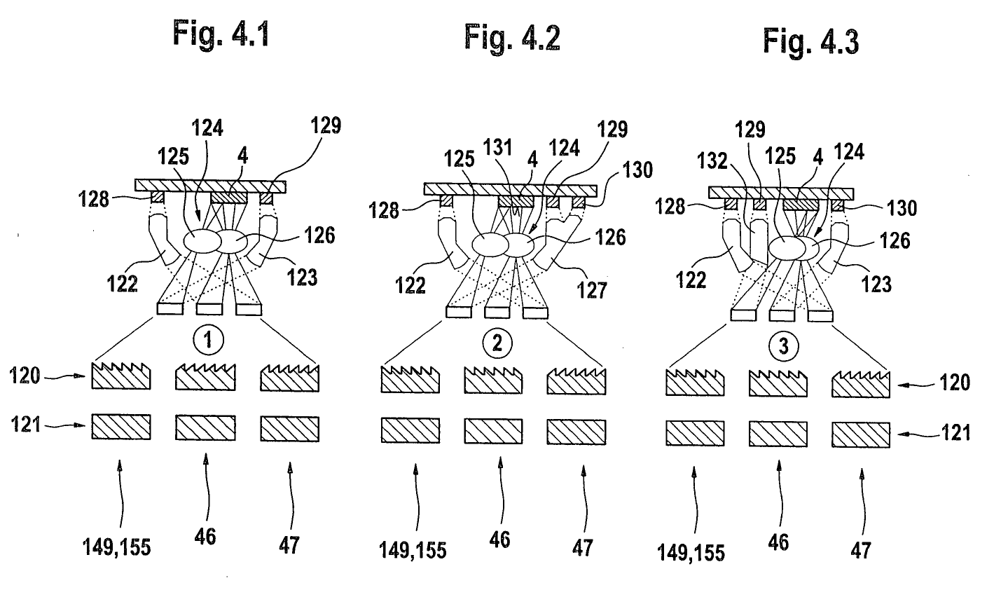

FIGS. 4.1,4.2 and 4.3 show sequential measurement arrangements for code-carriers, having patterned surface-regions.

According to the first solution given in FIG. 4.1, a turning mark profile 120 of the output-code-disk 46 and the input-code-disk 47, respectively, is arranged in the same orientation, whereas the turning mark profile 120 of the multiturn-code-disks 149, 155 is oriented in opposite direction as compared to the turning marks 120 of the output-code-disk 46, and the input-code-disk 47, respectively.

On the bottom of a printed circuit board the ASIC 4 is mounted in between a first port 128 and a second port 129. Below that first port 128 and said second port 129 a first angled light guide 122 and a second angled light guide 123 is arranged. By means of the second angled light guide 123 the turning mark profile 120 of the multiturn disk 149, 155 is detected. The reflected arrays from the turning mark profile 120 arranged on the surface of the multiturn-code-disks 149, 155, respectively, is focused by a first lens 125 of the lens combination 124 on an array—not given in greater detail here—of ASIC 4. The reflected arrays of the light, emitted by the first angled light guide 122 is focused by a second lens 126 of the lens combination 124 on respective arrays on the surface of the ASIC 4 oriented towards the lens combination 124.

According to the measurement arrangement given in FIG. 4.2 a first port 128, a second port 129 and a third port 133 are arranged on the lower surface of the printed circuit board. Between said first port 128 and said second port 129 the ASIC 4 is mounted. As given in the exemplary embodiment shown in FIG. 4.1 a lens combination 124, including a first lens 125 and a second lens 126 is mounted in between the ASIC 4 and the turning mark profile 120. The first angled light guide 122, assigned to the first port 128, directs light to the turning marks 120 of the input-code-disk 47. A combined light guide 127, assigned to the second port 129 and the third port 130, directs its light to the surfaces of the output-code-disk 46 and the multiturn-code-disk 149, 155.

The first lens 125 focuses the reflected rays from the code pattern of the surface of multi-turn-code-disk 149, 155, respectively, on of an assigned array of ASIC 4. The reflections of the surfaces of the input-code-disk 47, and the output-code-disk 46 are focused by second lens 126 on the surface 131 of the ASIC 4.

FIG. 4.3 shows a third solution of a measuring arrangement in which first port 128, second port 129 and third port 130 arranged on the lower surface of a printed circuit board. According to this exemplary embodiment a first angled light guide 122 emits light onto the surface of the input-code-disk 47, whereas the single light guide 132 emits a light only to the surface of the multiturn-code-disk 149, 155, respectively. A second angled light guide 123, assigned to the third port 130 of the printed circuit board emits light onto the surface of output-disk 46.

The structure of the code of the multiturn-code disc and the input-code disc have the same orientation in relation to the angle based laser marks. The orientation of the turning marks are not afflicted therefrom. The turning marks only shall reflect the light to the lens. The angle of the turning marks only depends on the light guide and the position of the LED and the positions of the lenses. That means, that in the solutions 1, 2 and 3 the code disks including the code are imaged to the same region of the ASIC by the two lenses. Therefore the ASIC is able to read both codes, the code of the turning mark and the code of the laser mark or the combination thereof.

FIG. 5 shows a gear assembly providing a multiturn disk in a first exemplary embodiment according to the present invention.

FIG. 5 shows a TAS-module 140 assigned to the outer circumference of a steering wheel shaft 152. Within the TAS-module 140 the ASIC 4 is arranged above a lens combination 124, including the first lens 125 and the second lens 126. Below the lens arrangement 125, 126 a detecting area 148 is identified.

Assigned to the outer circumference of the steering wheel shaft 152 is the input-code-disk 47 a distance 150 from the output-code-disk 46, also arranged on the outer circumference of the steering wheel shaft 152. Further, according to the first exemplary embodiment of the present invention a first multiturn disk 149 is mounted to or assigned with respect to the outputcode-disk 46.

The first multiturn-code-disk 149 includes an inner gearing 143, having arranged a plurality of teeth 153 on its circumference. The inner gearing 143 cooperates with an outer gearing 144 having a plurality of outer teeth 154 arranged thereon. A meshing zone of the inner teeth 153 with the respective outer teeth 154 is identified with reference numeral 145. Opposite the meshing zone 145, reference numeral 146 identifies the maximum eccentricity 146 of the gearing 142 assigned to the first multiturn-code-disk 149. Said gearing 142 is integrated into a combined bearing 141 which is arranged on the outer circumference of the steering-wheel-axle 152. A sealing element 147 (O-ring) is mounted on the respective side of the gearing 142 which is oriented to the output-code-disk 46. This may be derived from FIG. 5, the arrangement of which is similar to the arrangement given in previously mentioned FIG. 4. The outer circumference of the first multiturn-code-disk 149 reflects light which is focused by first lens 125 on the surface 131 of ASIC 4. The reflected light generated by an illuminating system which is not given in greater detail in the exemplary embodiment according to FIG. 5, is focused by second lens 126 onto the surface 131 of ASIC 4. Due to the eccentricity 146 between the inner gearing 143 and the outer gearing 144 of the gearing 142 a different number, depending on the gear ratio of multiturn signals is detected by the first lens 129 and focused on the respective array on the ASIC 4 assigned into the TAS-module 140. The input-code-disk 47 and the output-code-disk 46, respectively, however, rotate without eccentricity and reflect radiation onto the second lens 126, which focuses the reflected rays onto the ASIC 4 of the TAS-module 140. The solution given in FIG. 5 may allow sequential measurement of two code disks at the same time. The measurement of two code disks at the same time enhances the reliability and the performance of the measurement principle.

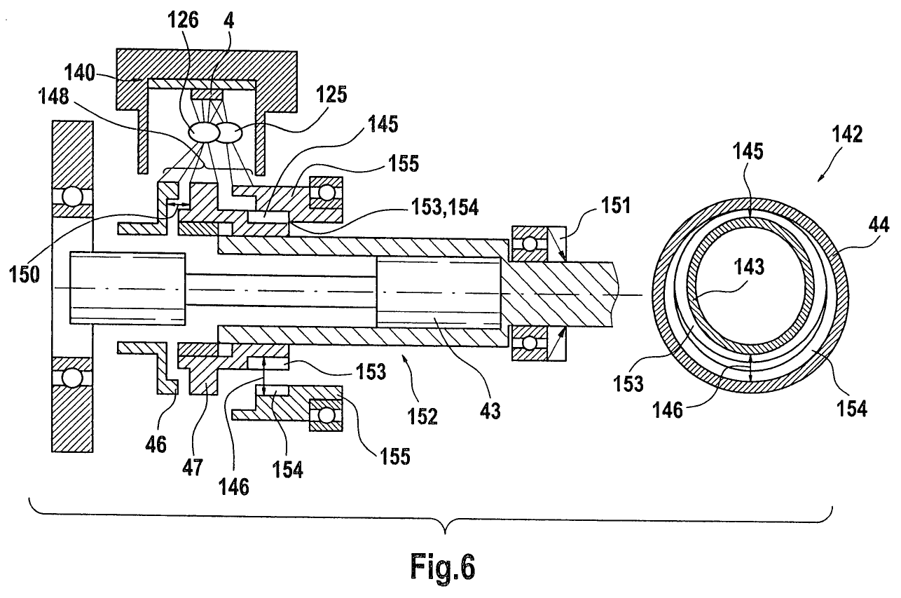

FIG. 6 shows a gear assembly providing a multiturn disk in a second exemplary embodiment according to the present invention.

According to the exemplary embodiment given in FIG. 6 a second multiturn-code-disk 155 is assigned to the input-code-disk 47. The second multiturn-code-disk 155 includes plurality of inner teeth 153 cooperating with a plurality of outer teeth 154 in a meshing zone 145. Opposite the meshing zone 145 the maximum eccentricity between the inner teeth 153 and the outer teeth 154 is depicted by reference numeral 146. According to the eccentricity, defining the gear ratio between the inner gearing 143 and the outer gearing 144 of the gearing 142 a code pattern sequence is generated which is focused by first lens 125 on ASIC 4 added in TAS-module 145. In this exemplary embodiment a ball bearing is assigned to a second multiturn-code-disk 155. The distance between the output-code-disk 46 and the input-code-disk 47 is identified by reference numeral 150. The surface patterns of the input-code-disk 47 and the output-code-disk 46, respectively, is detected by the second lens 126 which focuses the reflected light rays onto the lower surface 131 of the ASIC 4.

On the right hand side of FIGS. 5 and 6, respectively, a side-elevation of gearing 142 is shown. Within meshing zone 145 the inner teeth 143 of inner gearing 143 mesh with outer teeth 154 of outer gearing 144 of the gearing 142. Opposite the meshing zone 145 the maximum eccentricity is labeled with reference numeral 146. The turning ratios 1:1,05 (i.e. 4 turns), 1:1,025 (8 turns) according to FIG. 3.1 and the gear ratios given in FIG. 3.2, i.e. 1:1,0625 (4 turns) and 1:1,03125 (8 turns) are defined by the eccentricity 146 the number of inner teeth 153 assigned to the inner gearing 143 and consequently the number of outer teeth 154 assigned to the outer gearing 144 of the gearing 142. In both exemplary embodiments according to FIGS. 5 and 6 of the present invention, the hollow interior of the steering wheel shaft 152 surrounds a torsion element 43, which is not given in greater detail in this figures.

According to the first and second exemplary embodiment of the present invention given in FIGS. 5, 6, respectively, the measurement of the surfaces of the first multiturn disk 149, and the second multiturn disk 155, respectively, is performed without an additional ASIC 4, i.e. by sequential illumination of input-/output-code-disk 47,46 and the multiturn-code-disk 149, 155 a second ASIC device 4 is superfluous. Since the nonius-measurement principle is integrated to calculate the number of multiturns of the rotatable component, i.e. in this case a steering wheel shaft 152 no discharge of a vehicle battery may occur.

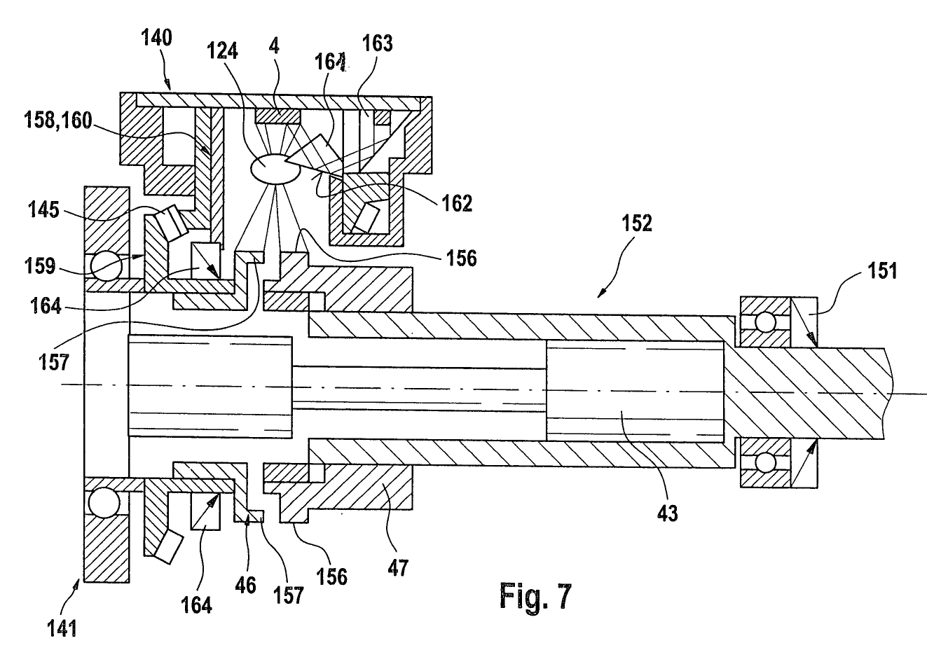

FIG. 7 shows the gear assembly with the bevel-gear assembly in a third exemplary embodiment of the present invention.

This exemplary embodiment of the present invention distinguishes over the first and second exemplary embodiments of the present invention as given in FIGS. 5, 6, respectively, as a bevel gear arrangement 159 is provided. On the outer circumference of a steering wheel shaft 152 an inputcode-disk 47 is spaced in a distance 150 from an output-code-disk 46. The output-codedisk 46 is provided with a bevel gear which cooperates with a bevel gear code disk 160 arranged in a modified TAS-module 140. Within meshing zone 145 the bevel gear assigned to the outer circumference of the output-code-disk 46 cooperates with the bevel gear code disk 160.

Within the housing of the modified TAS-module 140 a lens combination 124 is arranged, which cooperates with ASIC 4 arranged on the sealing of the respective housing. Below said lens arrangement 124 the light reflections of the circumferential surfaces 156, 157 of the input-code-disk 47 and the output-code-disk 46 are focused and transferred to the ASIC 4 arranged in the modified TAS-module 140. The code structure of the multiturncode-disk 160 (angle based transmission holds) and the respective input-code-disk 47 (having angle-based laser mark) is the same. In the arrangement according to FIG. 7 of the present invention a prism 161 is assigned to or incorporated in the ASIC 4 within the modified TAS-module 140. On a lower plane 162 of the prism 161 light is reflected to a receiving unit 163, being arranged within the modified TAS-module 140. Sealing elements 164 are arranged between the moving components of the arrangement according to FIG. 7 to prevent humidity from entering the hollow interior of the modified TAS-module 140. A further sealing element 151 is assigned to a ball bearing arranged on the outer circumference of the steering wheel shaft 152.

According to the present invention the nonius-principle with phase-angle behavior is based on the modified nonius calculation of the multiturn-code-disk 149, 155 using 2 code-disk's information. The n-dimensional nonius calculation principle makes use of 3-code-disks in information, i.e. the pattern information of the input-code-disk 47, the output-code-disk 46 and the multiturn-code-disk 149, 155, respectively. The modified nonius calculation using 2-code-disk information is performed by sequential measurement of the respective 2-code-disks 47, 46 or 47, 149, 155 or 46, 149, 155, respectively. The first multiturn-code-disk 149 and the second multiturn-code-disk 155 may be assembled on an steering-wheel axle of a vehicle having three laser marks assigned thereto. The sequential measurement of the patterned regions of the different code disks 46, 47, 149, 155 is performed by sequential illumination of the respective disks the surfaces of which are detected in different sequential modes.

1-15. (canceled)

16. A method for detection of patterned regions of a plurality of code-carriers assigned to a rotating component, by using an optical sensor arrangement including an illumination arrangement, comprising:
detecting illuminated reflections of the patterned regions upon rotation of the code-carriers and focusing the reflections on a surface array of a surface of an ASIC-component; and
assigning a multiturn-code-carrier having a detectable surface to the rotating component, the multiturn-code-carrier being rotated by the rotating component in a rotating ratio different from a rotating ratio of the code-carriers having the patterned regions;
wherein turns of the rotating component are detected by nonius calculation using code information of at least two code carriers selected from the plurality of code-carriers having the patterned regions and the multiturn-code-carrier.

17. The method of claim 16, wherein the nonius calculation includes a modfied nonius calculation using code information of at least two code carriers selected from the plurality of code-carriers having the patterned regions and the multiturn-code-carrier.

18. The method of claim 16, wherein the nonius calculation includes an n-dimensional nonius calculation using code information of at least three code carriers selected from the plurality of code-carriers having the patterned regions and the multiturn-code-carrier.

19. The method of claim 16, wherein the code-carriers and the multiturn-code-carrier are illuminated one of sequentially and simultaneously for producing an image containing information for determining the turns of the rotating component.

20. The method of claim 19, wherein the plurality of code carriers include an input code carrier, and wherein a coded pattern image of angle-based laser marks on the multiturn-code-carrier correspond to a coded pattern image of angle-based laser marks on the input code-carrier.

21. The method of claim 19, wherein the plurality of code carriers include an output code carrier, and wherein a coded pattern image of angle-based laser marks on the multiturn-code-carrier correspond to a coded pattern image of angle-based laser marks on the output code-carrier.

22. The method of claim 16, wherein turning marks on circumferential surfaces of the plurality of code-carriers and the multiturn-code-carrier are arranged non-symmetrically to increase an illumination efficiency of an illumination arrangement for generating the illuminated reflections.

23. A device for detection of patterned regions of a plurality of code-carriers assigned to a rotatable component, comprising:
a multiturn-code-carrier assigned to the rotatable component, the multiturn-code-carrier being rotated by the rotating component in a rotating ratio different from a rotating ratio of the plurality of code-carriers; and
an illumination arrangement for illuminating at least the patterned regions of the plurality of code-carriers and producing reflections from the patterned regions; and
a lens system for focusing the reflections onto a first surface portion of an ASIC-component.

24. The device of claim 23, wherein the lens system is a double lens system including a first lens and a second lens arranged within a housing, one of the first lens and the second lens being assigned to the multiturn-code-carrier, wherein the illumination arrangement illuminates the multiturn-code-carrier, and wherein reflections of the multiturn-code-carrier are focused onto a second surface portion of the ASIC-component.

25. The device of claim 23, wherein the lens system is a double lens system that focuses onto a surface portion of the ASIC-component reflected images of patterned regions of at least two code carriers selected from the plurality of code carriers and the multiturn-code-carrier.

26. The device of claim 23, wherein a maximum contrast of an image focused on the ASIC component is generated by non-symmetrical turning marks and angle-based laser marks.

27. The device of claim 23, wherein the illumination arrangement illuminates the multiturn-code-carrier.

28. The device of claim 23, wherein the multiturn-code-carrier is assigned to one of the plurality of code-carriers.

29. The device of claim 24, wherein the second lens focuses reflections of surfaces of the plurality of code-carriers.
